(19) United States
(12) Patent Application Publication
(10) Pub. No.: US 2025/0360912 A1
(43) Pub. Date: Nov. 27, 2025

(54) VERTICAL COUPLING LOADS FOR VEHICLE COMBINATIONS

(71) Applicant: VOLVO TRUCK CORPORATION, Göteborg (SE)

(72) Inventors: Christian OSCARSSON, Stenungsund (SE); Richard LÖFWENBERG, Göteborg (SE); Mats FAGERGREN, Kungälv (SE); Carl-Johan RUNDQVIST, Alingsås (SE); Charlotte HOLMEN, Göteborg (SE)

(73) Assignee: VOLVO TRUCK CORPORATION, Göteborg (SE)

(21) Appl. No.: 19/213,271

(22) Filed: May 20, 2025

(30) Foreign Application Priority Data
May 21, 2024 (EP) 24177054.4

(51) Int. Cl. B60W 30/02; B60D 1/62; B60W 10/04; B60W 10/22

(52) U.S. Cl. CPC B60W 30/02; B60D 1/62; B60W 10/04; B60W 10/22; B60W 2300/14; B60W 2530/10; B60W 2710/22; B60W 2720/40

(57) ABSTRACT

A computer system controls a vertical load on a coupling between units of a vehicle combination comprising a trailing unit and a preceding unit. The trailing unit has two or more axles and is coupled to the preceding unit via the coupling. The computer system has processing circuitry to acquire a current value of a vertical load on the coupling; determine a coupling load capability based on the current value of the vertical load on the coupling and a current value of a virtual wheelbase of the trailing unit; and determine a desired vertical load on the coupling based on the coupling load capability.

### TECHNICAL FIELD

The disclosure relates generally to vehicle control. In particular aspects, the disclosure relates to vertical coupling loads for vehicle combinations. The disclosure can be applied in heavy-duty vehicles, such as trucks, buses, and construction equipment. In particular, the disclosure can be applied in multi-unit vehicle combinations with distributed propulsion and energy storage. Although the disclosure may be described with respect to a particular vehicle, the disclosure is not restricted to any particular vehicle.

### BACKGROUND

In motion management of multi-unit vehicle combinations, various regulations exist governing the maximum allowable load for axles of a tractor or a trailer. In some countries, a limit of 10 tons per axle, or 11.5 tons per driven axle may be set. In some countries, exceeding this limit by up to 30% is allowed when the truck/trailer is intended to be moving at a speed that is less than a given threshold (e.g., 30 kph). Other regulations may exist, but they tend to include a maximum load per axle, as this may be a relevant factor for the safety of the vehicle and the longevity of road surfaces.

This limits the amount of load that can be carried by a trailer, therefore limiting operational efficiency. Furthermore, although electric vehicles, and in particular electric tractors, may be heavier than internal combustion engine vehicles, the same load limit may apply to these vehicles. Therefore, the payload that can be loaded in the trailers of electric vehicles may need to be lower than for internal combustion engine vehicles, further reducing the operational efficiency. Axle loads can also have an impact on traction of the vehicle combination.

It is therefore desired to develop a solution for vehicle motion management that addresses or at least mitigates some of these issues.

### SUMMARY

This disclosure provides systems, methods and other approaches for controlling a vertical load on a coupling between units of a vehicle combination. In particular, a current value of a vertical load on the coupling is acquired. Based on the current value of the vertical load on the coupling and a current value of a virtual wheelbase of a trailing unit, a maximum and/or minimum load capability for the coupling can be determined. Based on the coupling load capability, a desired vertical load on the coupling can be determined. The desired vertical load can then be set based on a desired outcome, for example an increase in the load that can be carried by the trailing unit, or a redistribution of traction between the units.

According to a first aspect of the disclosure, there is provided a computer system for controlling a vertical load on a coupling between units of a vehicle combination comprising a trailing unit and a preceding unit wherein the trailing unit comprises two or more axles and is coupled to the preceding unit via the coupling, the computer system comprising processing circuitry configured to acquire a current value of a vertical load F₁ on the coupling, determine a coupling load capability F_{1,cap} based on the current value of the vertical load F₁ on the coupling and a current value of a virtual wheelbase L of the trailing unit, and determine a desired vertical load F_{1,req} on the coupling based on the coupling load capability F_{1,cap}.

The first aspect of the disclosure may seek to provide a computer system that enables a vertical load applied to or borne by a coupling between units of a vehicle combination to be controlled. This enables various improvements such as adjusting a load that can be carried by the trailing unit and/or the traction characteristics of the vehicle combination. This can be achieved in a simple manner by controlling loads on the axles of the trailing unit.

Optionally in some examples, including in at least one preferred example, the current value of the vertical load F₁ on the coupling is acquired by a first controller associated with the preceding unit and transmitted to a second controller associated with the trailing unit. A technical benefit may include that existing infrastructure of units of a vehicle combination can be utilised to implement improved control of a vertical coupling load.

Optionally in some examples, including in at least one preferred example, the coupling load capability F_{1,cap} is determined by a second controller associated with the trailing unit and transmitted to a first controller associated with the preceding unit. A technical benefit may include that existing infrastructure of units of a vehicle combination can be utilised to implement improved control of a vertical coupling load.

Optionally in some examples, including in at least one preferred example, the processing circuitry is configured to determine the coupling load capability F_{1,cap} by determining a maximum value Lₘₐₓ and/or a minimum value Lₘᵢₙ for the virtual wheelbase L of the trailing unit, and/or determining a maximum value Mₘₐₓ and/or a minimum value Mₘᵢₙ for the payload of the trailing unit. A technical benefit may include that improved control of a vertical coupling load is enabled.

Optionally in some examples, including in at least one preferred example, the coupling load capability F_{1,cap} comprises a maximum coupling load capability F_{1,cap,max} and/or a minimum coupling load capability F_{1,cap,min}. A technical benefit may include that improved control of a vertical coupling load is enabled within the physical limits of the vehicle combination.

Optionally in some examples, including in at least one preferred example, the desired vertical load F_{1,req} is determined by a first controller associated with the preceding unit and transmitted to a second controller associated with the trailing unit. A technical benefit may include that existing infrastructure of units of a vehicle combination can be utilised to implement improved control of a vertical coupling load.

Optionally in some examples, including in at least one preferred example, the processing circuitry is configured to determine the desired vertical load F_{1,req} based on a maximum coupling load limit F_{1,max}. A technical benefit may include that improved control of a vertical coupling load is enabled within regulatory limits of the vehicle combination.

Optionally in some examples, including in at least one preferred example, the processing circuitry is configured to determine the desired vertical load F_{1,req} based on a desired increase to a load that can be carried by the trailing unit and/or a desired redistribution of traction between the trailing unit and the preceding unit. A technical benefit may include that loading and/or traction conditions of the vehicle combination can be improved via control of a vertical coupling.

Optionally in some examples, including in at least one preferred example, the virtual wheelbase L of the trailing unit is defined between the coupling and a load centre G of the axles of the trailing unit. A technical benefit may include that improved control of a vertical coupling load is enabled.

Optionally in some examples, including in at least one preferred example, the processing circuitry is further configured to provide the desired vertical load F_{1,req} by adjusting the load on at least one axle of the trailing unit such that the longitudinal position of the load centre G of the axles of the trailing unit is translated. A technical benefit may include that improved control of a vertical coupling load is enabled in a simple manner using existing infrastructure of the vehicle combination.

Optionally in some examples, including in at least one preferred example, the processing circuitry is configured to adjust the load on at least one axle of the trailing unit by adjusting a suspension parameter associated with the axle. A technical benefit may include that improved control of a vertical coupling load is enabled in a simple manner using existing infrastructure of the vehicle combination.

According to a second aspect of the disclosure, there is provided a vehicle comprising the computer system of any preceding example. The second aspect of the disclosure may seek to provide a vehicle capable of controlling a vertical load applied to or borne by a coupling between units of the vehicle. This can be achieved in a simple manner by controlling loads on the axles of a trailing unit.

According to a third aspect of the disclosure, there is provided a computer- implemented method for controlling a vertical load on a coupling between units of a vehicle combination comprising a trailing unit and a preceding unit, wherein the trailing unit comprises two or more axles and is coupled to the preceding unit via the coupling, the method comprising acquiring, by processing circuitry of a computer system, a current value of a vertical load F₁ on the coupling, determining, by the processing circuitry, a coupling load capability based on the current value of the vertical load F₁ on the coupling and a current value of a virtual wheelbase L of the trailing unit, and determining, by the processing circuitry, a desired vertical load on the coupling based on the coupling load capability.

The third aspect of the disclosure may seek to provide a computer-implemented method that enables a vertical load applied to or borne by a coupling between units of a vehicle combination to be controlled. This enables various improvements such as adjusting a load that can be carried by the trailing unit and/or the traction characteristics of the vehicle combination. This can be achieved in a simple manner by controlling loads on the axles of the trailing unit.

According to a fourth aspect of the disclosure, there is provided a computer program product comprising program code for performing, when executed by processing circuitry, the computer-implemented method. The fourth aspect of the disclosure may seek to enable new vehicles and/or legacy vehicles to be conveniently configured, by software installation/update, to enable a vertical load applied to or borne by a coupling between units of a vehicle combination to be controlled. This can be achieved in a simple manner by controlling loads on the axles of the trailing unit.

According to a fifth aspect of the disclosure, there is provided a non-transitory computer-readable storage medium comprising instructions, which when executed by processing circuitry, cause the processing circuitry to perform the computer-implemented method. The fifth aspect of the disclosure may seek to enable new vehicles and/or legacy vehicles to be conveniently configured, by software installation/update, to enable a vertical load applied to or borne by a coupling between units of a vehicle combination to be controlled. This can be achieved in a simple manner by controlling loads on the axles of the trailing unit.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1A schematically shows a side view of a vehicle combination according to an example of the disclosure.

FIG. 1B schematically shows a top view of a vehicle combination according to an example of the disclosure.

FIG. 2A schematically shows a side view of a vehicle combination according to another example of the disclosure.

FIG. 2B illustrates parameters of a trailing unit that may enable determination of a maximum payload of the trailing unit according to an example of the disclosure.

FIG. 3 is a flow chart of a computer-implemented method according to an example of the disclosure.

FIG. 4 is a schematic diagram of a computer system for implementing examples disclosed herein.

Like reference numerals refer to like elements throughout the description.

### DETAILED DESCRIPTION

The detailed description set forth below provides information and examples of the disclosed technology with sufficient detail to enable those skilled in the art to practice the disclosure.

Various regulations exist governing the maximum allowable load for axles of a tractor or a trailer. Other regulations may exist, but they tend to include a maximum load per axle, as this may be a relevant factor for the safety of the vehicle and the longevity of road surfaces. This limits the amount of load that can be carried by a trailer, therefore limiting operational efficiency. Furthermore, axle loads can have an impact on traction of the vehicle combination.

To remedy this, systems, methods, and other approaches are provided for controlling a vertical load on a coupling between units of a vehicle combination. A trailing unit of a vehicle combination having two or more axles is coupled to a preceding unit, for example a tractor, via a coupling known as the kingpin or fifth wheel. A virtual wheelbase of the trailing unit can be defined between the coupling and a load centre of the axles of the trailing unit. By adjusting the respective loads on the axles of the trailing unit, the length of the virtual wheelbase and the load on the coupling point (the “kingpin load”) can be adjusted. This can be used to adjust a load that can be carried by the trailing unit and/or the traction characteristics of the vehicle combination.

In particular, a current value of a vertical load on the coupling is acquired, for example by a first controller associated with the preceding unit. Based on the current value of the vertical load on the coupling and a current value of the virtual wheelbase of the trailing unit, a maximum and/or minimum load capability for the coupling can be determined, for example by a second controller associated with the trailing unit. The maximum and/or minimum coupling load capability may be calculated based on possible load redistribution of the axles of the trailing unit. Based on the maximum and/or minimum coupling load capability, a desired vertical load on the coupling can be determined, for example by the first controller. The desired vertical load can then be set based on a desired outcome, for example an increase to the load that can be carried by the trailing unit, or a redistribution of traction between the units.

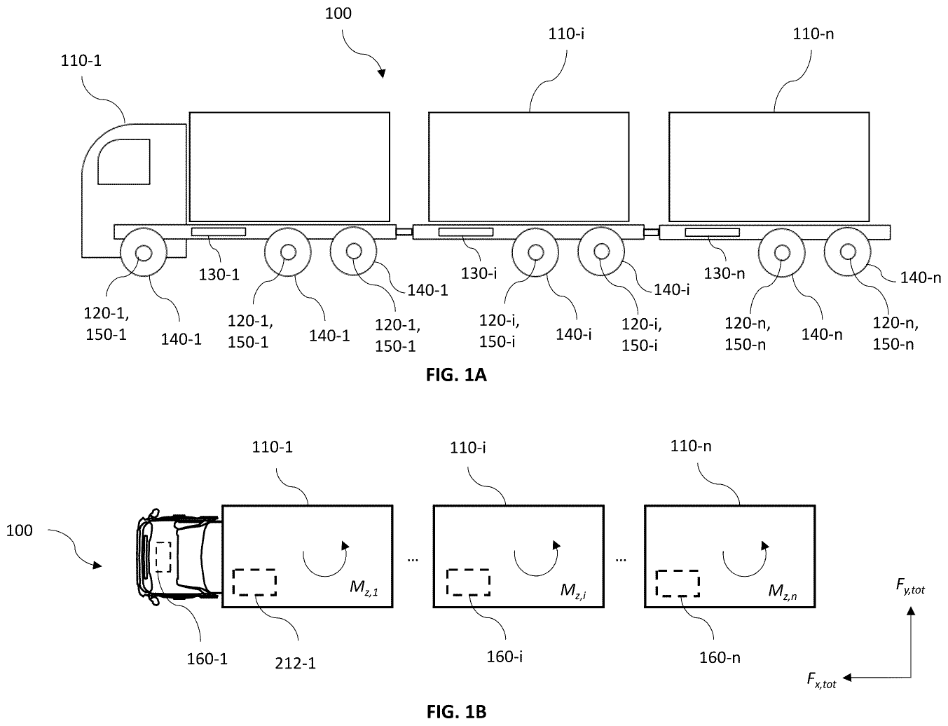

FIG. 1A schematically shows a side view of an example vehicle combination 100 of the type considered in this disclosure. The vehicle combination 100 comprises a number of units 110, including a tractor unit and at least one trailing unit. Each unit 110 may be given an index i, and the total number of units 110 in a vehicle combination 100 is designated n. Whilst two trailing units are shown, it will be appreciated that the vehicle combination 100 may comprise more or fewer trailing units connected to each other. This gives rise to different types and designations of vehicle combinations.

A tractor unit, such as the tractor unit 110-1, is generally the foremost unit in a vehicle combination 100, and may comprise the cabin for the driver, including steering controls, dashboard displays and the like. Generally, the tractor unit 110-1 is used to provide propulsion power for the vehicle combination 100. In the example of FIG. 1A, the tractor unit 110-1 may also be used to store goods that are being transported by the vehicle combination 100.

A trailing unit, such as the trailing units 110-i, 110-n, is generally used to store goods that are being transported by the vehicle combination 100. A trailing unit may be a truck, trailer, dolly and the like. A trailing unit may also provide propulsion to the vehicle combination 100. A trailing unit without a front axle, such as the trailing units 110-i, 110-n, is known as a semi-trailer. In vehicle combinations such as that shown in FIG. 1A, vehicle motion management is available on a unit level to receive requests from a manual or virtual driver to coordinate the propulsion, braking and steering.

An axle is a set of wheels (one or more pairs) comprising rims and tyres aligned at a longitudinal location. Whilst three tractor axles and two axles per trailer are shown, it will be appreciated that any suitable number of axles may be provide on the respective units 110. It will also be appreciated that any number of the tractor axles and/or trailer axles may be driven axles, including zero (i.e. one of the units may include at least one driven axle while the other does not).

The vehicle combination 100 may comprise one or more sources or propulsion. For example, on or more of the units 110 may comprise one or more electrical machines 120 such as electric motors. Each unit 110 may comprise one or more batteries 130 configured to provide power to the electrical machines 120. A vehicle combination 100 that uses only battery power is a BEV. In some examples, for example in the case of an HEV, a unit 110, most often a tractor unit 110-1, may also include another source of propulsion, for example an internal combustion engine (ICE). The vehicle combination 100 also comprises a drivetrain (not shown) to deliver mechanical power from the propulsion source (the electrical machines 120 or the ICE) to the wheels 140. All units 110 may provide propulsion to the vehicle combination 100. In the examples discussed herein, the vehicle combination 100 may be a BEV or an HEV.

The electrical machines 120 are configured to drive, e.g. provide torque and/or steering to, one or more axles or individual wheels 140 of the unit 110. The electrical machines 120 of a unit 110 can supply either a positive (propulsion) or negative (braking) force. In some examples, electric motors may also be operated as generators, in order for the electric motors to generate braking force when required. The use of electrical machines 120 to supply a negative force is known as regenerative braking. The energy recovered from regenerative braking can be stored in the batteries 130, and so regenerative braking is generally preferred over using service brakes 150.

Furthermore, each unit 110 may comprise one or more sets of service brakes 150. The service brakes 150 of a unit 110 can supply a negative (braking) force. The service brakes 150 may be, for example, frictional brakes such as pneumatic brakes. Pneumatic brakes use a compressor to fill the brake with air, which may be powered by the batteries 130. In some examples, the brakes may be electro-mechanical brakes or hydraulic brakes.

The vehicle combination 100 may also comprise one or more auxiliary systems (not shown). The auxiliary systems may include auxiliary mechanical systems, such as alternators, power take-off (PTO) systems, and an air compressors, and auxiliary electrical systems, such as steering pumps, headlights, other light systems, ignition systems, audio systems, and air conditioning systems.

The ICE, electrical machines 120 and service brakes 150 are considered as actuators of the vehicle combination 100. Other actuators may also be present. For example, steering actuators 150, such as steering servo arrangements, may be provided, and may be implemented as electro-hydraulic actuators. Each actuator in a given unit 110 may be given an index k, and the total number of actuators in a given unit 110 is designated m. It will be appreciated that each axle and/or wheel 140 may have an associated electrical machine 130, set of service brakes 150, and/or set of steering actuators.

The vehicle combination 100, or indeed one or more (e.g. each) units 110, can be considered to comprise two systems: a propulsion system comprising the components that are involved in propulsion of the vehicle combination 100, and a braking system comprising the components that are involved in braking of the vehicle combination 100. As such, the propulsion system can be considered to comprise one or more of the ICE, electrical machines 120, the drivetrain, and batteries 130 of the vehicle combination 100, while the braking system can be considered to comprise the ICE, the electrical machines 120, the drivetrain, the batteries 130, and the service brakes 150. As such, there is some overlap between the propulsion system and the braking system.

FIG. 1B schematically shows a top view of an example vehicle combination 100 of the type considered in this disclosure. Similarly to the example of FIG. 1A, the vehicle combination 100 comprises a number of units 110, including a tractor unit and a plurality of trailing units. FIG. 1B also shows the requested global forces of the vehicle combination 100 as a whole. Examples of requested global forces of the vehicle combination 100 as a whole may e.g. include a total longitudinal/axial force F_{x.tot} a total lateral/radial force F_{y.tot}, and/or one or more yaw moments Mai for the respective vehicle units 110. In order to control motion of a vehicle combination 100, the requested global forces of the vehicle combination 100 must be determined and resolved. This may be achieved by a control system of the vehicle combination 100 that determines control signals based on a requested reference input and certain operating conditions of the vehicle combination 100.

As shown in the example of FIG. 1B, each unit 110 of the vehicle combination 100 has a respective controller 160. The tractor unit controller 160-1 may include an implementation of a combination control allocator, while each controller 160 may include an implementation of a respective unit control allocator. The controller 160 (including the combination control allocator and the various unit specific control allocators) together form a distributed control allocation system for the vehicle combination 100. In this system, the control allocation may be performed on multiple levels, i.e. first on a level of the vehicle combination 100 as a whole, and then on a level of each vehicle unit 110 individually. It will be appreciated that the combination control allocator may be provided as part of any unit 110 of the vehicle combination 100.

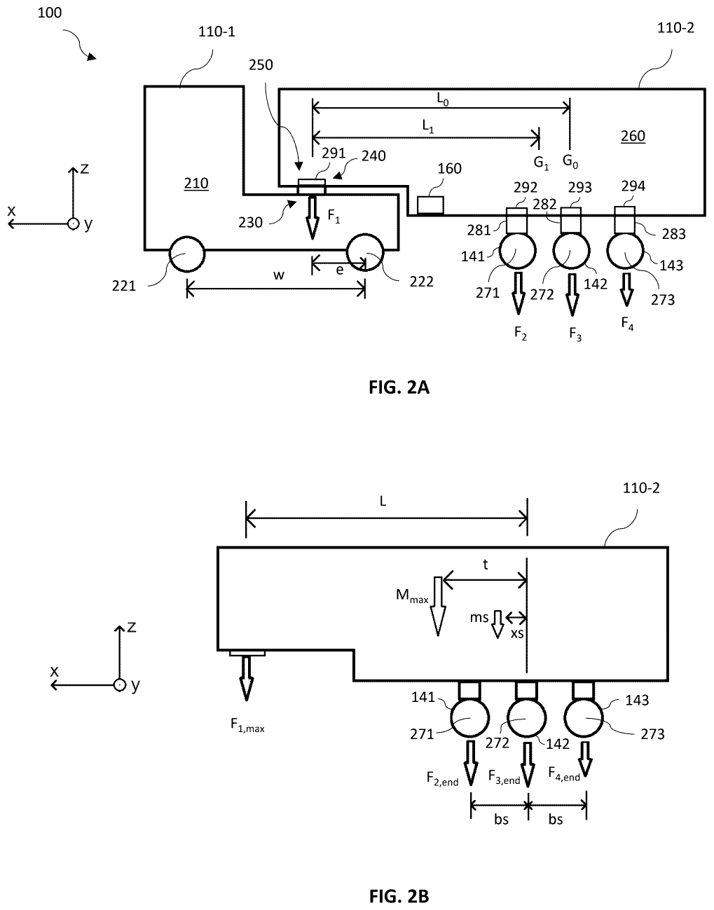

FIG. 2A schematically shows a side view of another example vehicle combination 100 of the type considered in this disclosure. The vehicle combination 100 comprises a tractor unit 110-1 and a trailing unit 110-2. The direction x is a longitudinal direction, the direction y is a transversal direction, and the direction z is a vertical direction.

The tractor unit 110-1 is shown as having a chassis 210 supported by a number of axles 220, in this example two axles 221, 222. In this example, at least one of the axles 221, 222 is a driven axle. The distance between the two axles 221, 222 of the tractor unit 110-1 is known as the wheelbase w of tractor unit 110-1. The loads applied to or borne by the respective axles 221, 222 of the tractor unit 110-1 are denoted F₂₁ and F₂₂.

The tractor unit 110-1 also comprises a fifth wheel 230 intended to support and connect to the trailing unit 110-2. The fifth wheel 230 is located at a distance e from the rearmost axle 222 of the tractor unit 110-1.

The trailing unit 110-2 may be removably connected to the tractor unit 110-1. To that end, the trailing unit 110-2 comprises a kingpin 240 connectable to the fifth wheel 230 to form a coupling 250 between the tractor unit 110-1 and the trailing unit 110-2. The trailing unit 110-2 further comprises a chassis 260 intended to receive goods to be transported. The load applied to or borne by the coupling 250 (e.g. the fifth wheel 230 and/or the kingpin 240) is denoted F₁.

The chassis 260 of the trailing unit 110-2 is supported by a number of axles 270, in particular at least two axles. In this example, the at least two axles comprise a foremost axle 271, an intermediate axle 272, and a rearmost axle 273. Each axle comprises a respective set of wheels 141, 142, 143. The loads applied to or borne by the respective axles 271, 272, 273 of the trailing unit 110-2 are denoted F₂, F₃, and F₄.

The axles 270 are connected to the chassis 260 of the trailing unit 110-2 by means of suspension systems 280, in particular respective suspension systems 281, 282, 283. The suspension systems 281, 282, 283 are adjustable independently, i.e., the spring rate, damping, and/or suspension travel may be set differently and/or may be dynamically and independently controlled. The parameter of the suspension systems 280 that can be adjusted may be a suspension stiffness, denoted k₁, k₂, k₃ respectively. In some examples, the suspension is hydraulic or electro-mechanical. In some examples, the suspension contains an air bag, the pressure of which can be independently selected for each of the suspension systems 280 (in such a case, the regulated parameter is a pressure, denoted p₁, p₂, p₃). A relationship exists between pᵢ and kᵢ:

$${p}_{i} = {Dk}_{i} \frac{H}{2 A} \qquad ( 1 )$$

where pᵢ is the pressure of the airbag of axle i, k; is the stiffness of the suspension i, D is a geometrical constant, H is height of the airbag, and A is the area of the airbag.

When suspensions comprise air bags as noted above, F=p*A, where F is the load, p the pressure and A the area of the air bag. As the pressure is changed in the air bag, there is a conservation of the quantity pV/m as follows:

$${p}_{a} * \frac{{V}_{a}}{{m}_{a}} = {p}_{b} * \frac{{V}_{b}}{{m}_{b}} , \qquad ( 2 )$$

where a and b refer to two distinct loads on the same axis (e.g. before and after a transfer of load by action on the suspension parameters), pₐ and p_{b} are the pressures in the bellows for these two loads, Vₐ and V_{b} are the volumes of air in the bellows, and mₐ and m_{b} are the masses of air in the bellows.

Since the area A is not affected by either load or pressure, it follows that:

$$\frac{{F}_{a} * {h}_{a}}{{m}_{a}} = \frac{{F}_{b} * {h}_{b}}{{m}_{b}} \qquad ( 3 )$$

where Fₐ and F_{b} are the loads before and after a changed of load; hₐ and h_{b} are the heights of the air bags, and mₐ and m_{b} are the masses of air in the bellows.

Equation (3) indicates that when the load is changed on an axle, if it is not accompanied by a change of mass of air, the height of the bellow will change (in inverse proportion to the change of load). This may affect the level and/or orientation of the trailer. A small change of level or orientation of the trailer may be acceptable. It may be advantageous, however, to act on the air mass in the airbag to compensate for the change of height of the bellow. For example, if it is desired for hₐ and h_{b} to be equal when the load increases on an axle (F_{b}>Fₐ), it is needed to increase the mass of air in the corresponding bellow with the same proportion (m_{b}>mₐ).

The trailing unit 110-2 may contain load measurement devices 290 (e.g., embedded load cells or external weighing mechanism lying on the floor of the loading dock), in particular a load measurement device 291 for the kingpin 240 and respective load measurement devices 294, 293, 294 for each axle 271, 272, 273. The load measurement devices 290 may be connected to a control unit which may be configured to receive signals from the load measurement devices 290 and which may control the suspension settings of the suspension systems 280 of the trailing unit 110-2. The control unit may be a controller 160-1 of the tractor unit 110-1, a controller 160-2 of the trailing unit 110-2, or may be a remote controller which is wirelessly connected to the load measurement devices 290.

A virtual wheelbase of the trailing unit 110-2 may be defined as the distance from the coupling 250 to a load centre G of the axles 270 of the trailing unit 110-2. The load centre may be defined as the average location of the load across the axles 270. It is the position at which the total load across the axles 270 may be considered to apply. In a default configuration, the settings of all the axles 271, 272, 273 are the same, meaning the load is evenly spread between the axles 271, 272, 273 and the load centre, in this instance denoted G₀, is located at about the same position as the intermediate axle 272. The virtual wheelbase of the trailing unit 110-2 in this instance is denoted L₀.

Legal regulations or technical constraints may limit the load per axle and may prescribe F_{2,max}, F_{3,max}, and/or F_{4,max}, for example as being 10 tons, or 11.5 tons when the respective axle 271, 272, 273 is a driven axle. Similarly, regulations or technical constraints may limit the load per axle of the tractor unit 110-1 F_{21,max}, F_{22,max}, for example to 10 tons.

Similarly, regulations or technical constraints may limit the load on the coupling 250 (e.g. the fifth wheel 230 and/or the kingpin 240) F_{1,max}. In some examples, F_{1,max} may be stored in a controller 160 of the vehicle combination 100. In some examples, the controller 160 may integrate with or be connected to a GPS system (e.g., an on-board GPS of the tractor unit 110-1) and may adjust a regulatory value of F_{1,max} based on the actual location of the vehicle combination 100. For instance, if the vehicle combination 100 enters a geographic area that allows more load the coupling 250 or axles 220, 270, the stored limit may be updated.

Alternatively, the limit F_{1,max} may be determined based on regulations or constraints on the axles 221, 222 of the tractor unit 110-1 as follows:

$${F}_{1 , ma x} = Min \{ ( GVW - {F}_{o} - {R}_{o} ) ; ( {F}_{21 , m ax} - {F}_{0} ) * \frac{w}{e} ; ( {F}_{22 , m ax} - {R}_{o} ) * \frac{w}{w - e} \} \qquad ( 4 )$$

where GVW is the gross weight of the tractor unit 110-1, F₀ is the unladen load on the front axle 221 of the tractor unit 110-1, and R₀ is the unladen load on the rear axle 222 of the tractor unit 110-1.

The load F₁ applied to or borne by the coupling 250 can therefore be related to the virtual wheelbase L of the trailing unit 110-2 as follows:

$${F}_{1} = mg ( 1 - \frac{L - t}{L} ) \qquad ( 5 )$$

where mg is the gross weight of the trailing unit 110-2, L is the virtual wheelbase of the trailing unit 110-2, and t is the distance between the load centre G of the axles 271, 272, 273 and the centre of mass of the fully laden trailing unit 110-2.

FIG. 2B illustrates parameters of the trailing unit 110-2 that may enable determination of the maximum payload Mₘₐₓ of the trailing unit 110-2 for a given geometry of trailing unit 110-2 (a trailing unit load capability). By simplification, this figure shows axles 271, 272, 273 being equidistant at a distance bs. The maximum load Mₘₐₓ that can be loaded on the trailing unit 110-2 can be determined as the minimum of:

$$( G C W - {F}_{0} - {R}_{o} - m s ) \qquad ( 6 )$$

$$\frac{1}{t + bs} * ( b s * ( 2 * {F}_{2 , e n d} + {F}_{3 , e n d} ) - m s * ( x s + b s ) ) + {F}_{1 , ma x} * ( L + b s ) \qquad ( 7 )$$

where GCW is the gross weight of the vehicle combination 100, ms is the unladen mass of the trailing unit 110-2, xs is the distance between the load centre G of the axles 271, 272, 273 and the centre of mass of the unladen trailing unit 110-2, and F_{2,end} and F_{3,end} are the loads on the axles 271, 272 (e.g., a predetermined value of 9 or 10 tons) when the trailing unit 110-2 is fully laden.

The load F_{4,end} on the rearmost axle 273 when the trailing unit 110-2 is fully laden can then be determined as:

$${F}_{4 , end} = {M}_{ma x} + m s - {F}_{1 , ma x} - {F}_{2 , e n d} - {F}_{3 , e n d} \qquad ( 8 )$$

Based on the concepts described above, the load F applied to or borne by the coupling 250 (e.g. the fifth wheel 230 and/or the kingpin 240), and therefore the maximum payload Mₘₐₓ of the trailing unit 110-2, can be controlled by adjusting the virtual wheelbase of the trailing unit 110-2. This can be achieved by moving the load centre G of the axles 270 via control of the loads on the individual axles 271, 272, 273 of the trailing unit 110-2. As explained in European patent application no. 23210070.1 filed on 15 Nov. 2023 in the name of Volvo Truck Corporation, the position of the load centre of the axles 270 may be adjusted, for example by adjusting the settings of the suspension 283 of the rearmost axle 273. For example, the air pressure in the suspension 283 may be reduced to relieve the rear axle 273 from part of its load F₄. FIG. 2A shows this configuration where the load F₄ is smaller than the loads F₂ and/or F₃. Relieving the load from the rearmost axle 273 moves the load centre of the axles 270 forward to a position G₁, as the foremost 271 and optional intermediate axle 272 bear more weight than the rearmost axle 273. As the load centre of the axles 270 is moved forward, the virtual wheelbase of the trailing unit 110-2 is shortened to L₁ (which is less than L₀). Whilst explained in relation to a tractor unit 110-1 and a trailing unit 110-2, it will be appreciated that similar concepts may be applied to consecutive trailing units connected via a coupling.

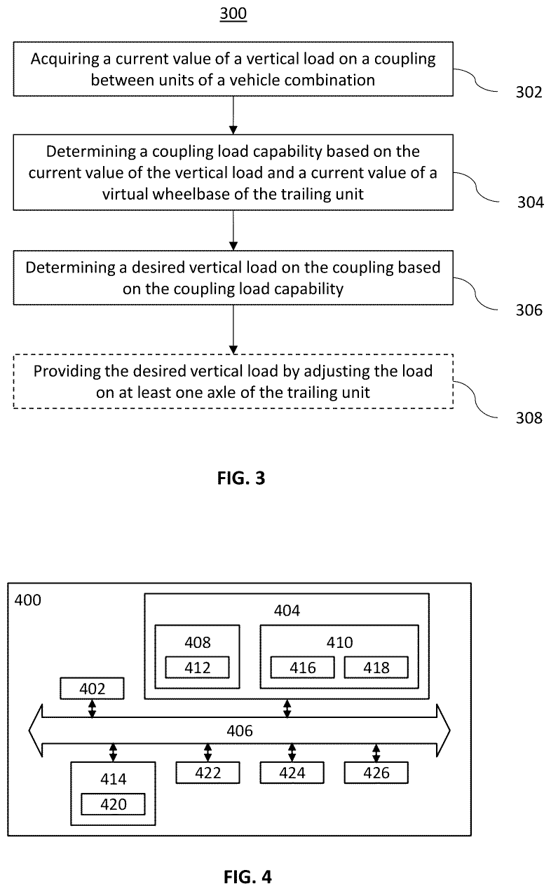

FIG. 3 is a flow chart of a computer-implemented method 300 according to an example. The method 300 is for controlling a vertical load on a coupling between units of a vehicle combination, such as the vehicle combination 100. The method 300 enables a load F₁ applied to or borne by the coupling, and therefore the maximum payload of a trailing unit, to be controlled. The method 300 may be implemented by processing circuitry of a computer system (e.g., any combination of the controllers 160).

At 302, a current value of a vertical load on a coupling between a preceding unit and a trailing unit is acquired. For example, a measured value of the load F₁ is provided from a sensor associated with the coupling 250. This may be a sensor and/or value associated with the fifth wheel 230 and/or the kingpin 240. In one particular example, the current value of a vertical load may be acquired by a first controller associated with a preceding unit and transmitted to a second controller associated with the trailing unit. For example, the controller 160-1 of the tractor unit 110-1 may acquire and transmit the value of a so-called “kingpin load” to the controller 160-2 of the trailing unit 110-2.

At 304, a coupling load capability F_{1,cap} is determined based on the current value of the vertical load on the coupling and a current value of a virtual wheelbase of the trailing unit. The coupling load capability may comprise a maximum coupling load capability F_{1,cap,max} and/or a minimum coupling load capability F_{1,cap,min} for the coupling. The maximum coupling load capability F_{1,cap,max} is the highest load that can physically be applied to the coupling 250, and may be a load applied to maximize traction on the tractor unit 110-1, or provide a smaller turning radius with a shorter virtual wheelbase. The minimum coupling load capability F_{1,cap,min} is the lowest load that should be applied to the coupling 250, and may be a load applied to maximize a payload of the trailing unit 110-2 or maximize traction on the trailing unit 110-2. In one particular example, the coupling load capability F_{1,cap} may be determined by the second controller associated with the trailing unit and transmitted to the first controller associated with the preceding unit. For example, the controller 160-2 of the trailing unit 110-2 may determine the coupling load capability F_{1,cap} and transmit it to the controller 160-1 of the tractor unit 110-1.

As discussed above, a value of the coupling load F₁ can be dependent on the virtual wheelbase L of the trailing unit, which is in turn dependent on the position of the load centre G of the axles 270 of the trailing unit 110-2. The position of the load centre G of the axles 270 of the trailing unit 110-2 is dependent on the individual axle loads F₂, F₃, F₄. The coupling load capability F_{1,cap} can therefore be determined in the same manner. For example, based on the load limits per axle, e.g. F_{2,max}, F_{3,max}, and/or F_{4,max}, a maximum (rearmost) longitudinal position Gₘₐₓ and/or minimum (foremost) longitudinal position Gₘᵢₙ of the load centre G of the axles 270 can be determined. This leads to a corresponding maximum value Lₘₐₓ and/or minimum value Lₘᵢₙ for the virtual wheelbase L of the trailing unit 110-2. This in turn leads to a maximum value F_{1,cap,max} and/or minimum for the coupling load F_{1,cap,min}, i.e. the coupling load capability F_{1,cap}. This may also correspond to a maximum value Mₘₐₓ and/or minimum value Mₘᵢₙ for the payload of the trailing unit 110-2.

At 306, a desired vertical load F_{1,req} on the coupling 250 is determined based on the coupling load capability F_{1,cap}. In one particular example, the desired vertical load F_{1,req} may be determined by the first controller associated with the preceding unit and transmitted to the second controller associated with the trailing unit. For example, the controller 160-1 of the tractor unit 110-1 may determine and transmit the desired vertical load F_{1,req} to the controller 160-2 of the trailing unit 110-2.

The coupling load capability F_{1,cap} may define maximum and minimum achievable limits for the vertical load F₁ on the coupling. Regulations or technical constraints may also limit the load on the coupling to F_{1,max}, as discussed above. Based on these values and a desired outcome, the desired vertical load F_{1,req} on the coupling can be determined. For example, if it is determined that the current value F₁ of the vertical load on the coupling 250 is above a lower coupling load capability F_{1,cap,min}, the maximum payload of the trailing unit 110-2 can be increased by providing a desired vertical load F_{1,req} that is lower than the current value F₁ of the vertical load. A similar approach may apply when it is desired to decrease the traction on the preceding unit 110-1 and/or increase the traction on the trailing unit 110-2. On the other hand, if it is desired to increase the traction on the preceding unit 110-1 and/or decrease the traction on the trailing unit 110-2, and the current value F₁ of the vertical load on the coupling 250 is below an upper coupling load capability F_{1,cap,max} (and F_{1,max}), a desired vertical load F_{1,req} can be provided that is higher than the current value F₁ of the vertical load.

At 308, the desired vertical load F_{1,req} may be implemented by adjusting the load on at least one axle 270 of the trailing unit 110-2. As discussed above, adjustment of the load on at least one axle 270 of the trailing unit 110-2 will cause a longitudinal translation of the load centre G of the axles 270. This will in turn cause an adjustment to the virtual wheelbase L of the trailing unit 110-2, which will lead to a change in the vertical load F₁ on the coupling 250. As discussed above, adjustment of the load on an axle 270 of the trailing unit 110-2 may be achieved by adjusting a suspension parameter associated with the axle 270. It will be appreciated that any axles that are lifted (i.e. not in contact with the ground) do not contribute to the position of the load centre of the axles. Therefore, if it is desired that such an axle is to contribute to the position of the load centre (e.g. during an adjustment of the load centre), it should be necessary to firstly lower this axle before any displacement or load adjustment is made.

In an example where it is desired to decrease the vertical load F₁ on the coupling 250, for example to increase the maximum payload of the trailing unit 110-2 or increase the traction on the trailing unit 110-2, the longitudinal position of the load centre G of the axles 270 should be moved forward to shorten the virtual L wheelbase of the trailing unit 110-2. This can be achieved, for example, by reducing the load on the rearmost axle 273 of the trailing unit 110-2. For example, suspension stiffness and/or the air pressure in the suspension 283 of the rearmost axle 273 may be reduced to relieve the rear axle 273 from part of its load F₄. Similarly, the load on an intermediate axle 272 may be adjusted appropriately. The adjustments can be made in an incremental manner to ensure the relevant capabilities and limits are not exceeded.

In an example where it is desired to increase the vertical load F₁ on the coupling 250, for example to increase the traction on the tractor unit 110-1, the longitudinal position of the load centre G of the axles 270 may be moved backward to lengthen the virtual wheelbase L of the trailing unit. This can be achieved, for example, by increasing the load on the rearmost axle 273 of the trailing unit 110-2 (or indeed reducing the load on the foremost axle 271 of the trailing unit 110-2). For example, the suspension stiffness and/or air pressure in the suspension 283 of the rearmost axle 273 may be increased, and/or the air pressure in the suspension 281 of the foremost axle 271 may be increased. Similarly, the load on an intermediate axle 272 may be adjusted appropriately. The adjustments can be made in an incremental manner to ensure the relevant capabilities and limits are not exceeded.

The suspension settings may be automatically modified while driving or to enable a manual operator to further modify the suspension settings while driving. This is done while ensuring that the vertical load on the coupling remains equal to or less than the threshold load F_{1,max}. Also, it may be ensured that other technical or legal constraints are respected. This may be helpful to improve traction when the vehicle combination moves uphill and/or under deteriorated conditions (snow, sand, etc.). For instance, the vertical load on the coupling can be lowered as much as possible when travelling on snow or ice to maximise traction. In some examples, the suspension settings may be automatically modified while driving for improving the agility of the trailer. In some examples, the increase of load on driven axles may be made conditionally to the vehicle combination moving below a given speed. For instance, in some countries, the axles can bear 30% more load below 30 kph than at higher speed. Under these circumstances, a new value for F_{1,max} can be acquired and a new value for the suspension settings may be set accordingly.

The method 300 enables a vertical load on a coupling between units of a vehicle combination to be controlled. This can be achieved by a distributed control system for the vehicle combination. This enables various improvements such as adjusting a load that can be carried by the trailing unit and/or the traction characteristics of the vehicle combination. This can be achieved in a simple manner by controlling loads on the axles of the trailing unit.

FIG. 4 is a schematic diagram of a computer system 400 for implementing examples disclosed herein. The computer system 400 is adapted to execute instructions from a computer-readable medium to perform these and/or any of the functions or processing described herein. The computer system 400 may be connected (e.g., networked) to other machines in a LAN (Local Area Network), LIN (Local Interconnect Network), automotive network communication protocol (e.g., FlexRay), an intranet, an extranet, or the Internet. While only a single device is illustrated, the computer system 400 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 400 may comprise at least one computing device or electronic device capable of including firmware, hardware, and/or executing software instructions to implement the functionality described herein. The computer system 400 may include processing circuitry 402 (e.g., processing circuitry including one or more processor devices or control units), a memory 404, and a system bus 406. The computer system 400 may include at least one computing device having the processing circuitry 402. The system bus 406 provides an interface for system components including, but not limited to, the memory 404 and the processing circuitry 402. The processing circuitry 402 may include any number of hardware components for conducting data or signal processing or for executing computer code stored in memory 404. The processing circuitry 402 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 402 may further include computer executable code that controls operation of the programmable device.

The system bus 406 may be any of several types of bus structures that may further interconnect to a memory bus (with or without a memory controller), a peripheral bus, and/or a local bus using any of a variety of bus architectures. The memory 404 may be one or more devices for storing data and/or computer code for completing or facilitating methods described herein. The memory 404 may include database components, object code components, script components, or other types of information structure for supporting the various activities herein. Any distributed or local memory device may be utilized with the systems and methods of this description. The memory 404 may be communicably connected to the processing circuitry 402 (e.g., via a circuit or any other wired, wireless, or network connection) and may include computer code for executing one or more processes described herein. The memory 404 may include non-volatile memory 408 (e.g., read-only memory (ROM), erasable programmable read-only memory (EPROM), electrically erasable programmable read-only memory (EEPROM), etc.), and volatile memory 410 (e.g., random-access memory (RAM)), or any other medium which can be used to carry or store desired program code in the form of machine-executable instructions or data structures and which can be accessed by a computer or other machine with processing circuitry 402. A basic input/output system (BIOS) 412 may be stored in the non-volatile memory 408 and can include the basic routines that help to transfer information between elements within the computer system 400.

The computer system 400 may further include or be coupled to a non-transitory computer-readable storage medium such as the storage device 414, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 414 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 414 and/or in the volatile memory 410, which may include an operating system 416 and/or one or more program modules 418. All or a portion of the examples disclosed herein may be implemented as a computer program 420 stored on a transitory or non-transitory computer-usable or computer-readable storage medium (e.g., single medium or multiple media), such as the storage device 414, which includes complex programming instructions (e.g., complex computer-readable program code) to cause the processing circuitry 402 to carry out actions described herein. Thus, the computer-readable program code of the computer program 420 can comprise software instructions for implementing the functionality of the examples described herein when executed by the processing circuitry 402. In some examples, the storage device 414 may be a computer program product (e.g., readable storage medium) storing the computer program 420 thereon, where at least a portion of a computer program 420 may be loadable (e.g., into a processor) for implementing the functionality of the examples described herein when executed by the processing circuitry 402. The processing circuitry 402 may serve as a controller or control system for the computer system 400 that is to implement the functionality described herein.

The computer system 400 may include an input device interface 422 configured to receive input and selections to be communicated to the computer system 400 when executing instructions, such as from a keyboard, mouse, touch-sensitive surface, etc. Such input devices may be connected to the processing circuitry 402 through the input device interface 422 coupled to the system bus 406 but can be connected through other interfaces, such as a parallel port, an Institute of Electrical and Electronic Engineers (IEEE) 1394 serial port, a Universal Serial Bus (USB) port, an IR interface, and the like. The computer system 400 may include an output device interface 424 configured to forward output, such as to a display, a video display unit (e.g., a liquid crystal display (LCD) or a cathode ray tube (CRT)). The computer system 400 may include a communications interface 426 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

According to certain examples, there is also disclosed:

Example 1: A computer system (160, 400) for controlling a vertical load on a coupling (230, 240, 250) between units (110) of a vehicle combination (100) comprising a trailing unit (110-2) and a preceding unit (110-1), wherein the trailing unit (110-2) comprises two or more axles (270) and is coupled to the preceding unit (110-1) via the coupling (230, 240, 250), the computer system (160, 400) comprising processing circuitry (402) configured to: acquire a current value of a vertical load F₁ on the coupling (230, 240, 250); determine a coupling load capability F_{1,cap} based on the current value of the vertical load F₁ on the coupling (230, 240, 250) and a current value of a virtual wheelbase L of the trailing unit (110-2); and determine a desired vertical load F_{1,req} on the coupling (230, 240, 250) based on the coupling load capability F_{1,cap}.

Example 2: The computer system (160, 400) of example 1, wherein the current value of the vertical load F₁ on the coupling (230, 240, 250) is acquired by a first controller (160-1) associated with the preceding unit (110-1) and transmitted to a second controller (160-2) associated with the trailing unit (110-2).

Example 3: The computer system (160, 400) of example 1 or 2, wherein the coupling load capability F_{1,cap} is determined by a second controller (160-2) associated with the trailing unit (110-2) and transmitted to a first controller (160-1) associated with the preceding unit (110-1).

Example 4: The computer system (160, 400) of any preceding example, wherein the processing circuitry (402) is configured to determine the coupling load capability F_{1,cap} by determining a maximum value Lₘₐₓ and/or a minimum value Lₘᵢₙ for the virtual wheelbase L of the trailing unit (110-2), and/or determining a maximum value Mₘₐₓ and/or a minimum value Mₘᵢₙ for the payload of the trailing unit (110-2).

Example 5: The computer system (160, 400) of any preceding example, wherein the coupling load capability F_{1,cap} comprises a maximum coupling load capability F_{1,cap,max} and/or a minimum coupling load capability F_{1,cap,min}.

Example 6: The computer system (160, 400) of any preceding example, wherein the desired vertical load F_{1,req} is determined by a first controller (160-1) associated with the preceding unit (110-1) and transmitted to a second controller (160-2) associated with the trailing unit (110-2).

Example 7: The computer system (160, 400) of any preceding example, wherein the processing circuitry (402) is configured to determine the desired vertical load F_{1,req} based on a maximum coupling load limit F_{1,max}.

Example 8: The computer system (160, 400) of any preceding example, wherein the processing circuitry (402) is configured to determine the desired vertical load F_{1,req} based on a desired increase to a load that can be carried by the trailing unit (110-2) and/or a desired redistribution of traction between the trailing unit (110-2) and the preceding unit (110-1).

Example 9: The computer system (160, 400) of any preceding example, wherein the virtual wheelbase L of the trailing unit (110-2) is defined between the coupling (230, 240, 250) and a load centre G of the axles (270) of the trailing unit (110-2).

Example 10: The computer system (160, 400) of any preceding example, wherein the processing circuitry (402) is further configured to provide the desired vertical load F_{1,req} by adjusting the load on at least one axle (270) of the trailing unit (110-2) such that the longitudinal position of the load centre G of the axles (270) of the trailing unit (110-2) is translated.

Example 11: The computer system (160, 400) of example 10, wherein the processing circuitry (402) is configured to adjust the load on at least one axle (270) of the trailing unit (110-2) by adjusting a suspension parameter associated with the axle (270).

Example 12: A vehicle (100) comprising the computer system (160, 400) of any preceding example.

Example 13: A computer-implemented method (300) for controlling a vertical load on a coupling (230, 240, 250) between units (110) of a vehicle combination (100) comprising a trailing unit (110-2) and a preceding unit (110-1), wherein the trailing unit (110-2) comprises two or more axles (270) and is coupled to the preceding unit (110-1) via the coupling (230, 240, 250), the method (300) comprising: acquiring (302), by processing circuitry (402) of a computer system (160, 400), a current value of a vertical load F₁ on the coupling (230, 240, 250); determining (304), by the processing circuitry (402), a coupling load capability based on the current value of the vertical load F₁ on the coupling (230, 240, 250) and a current value of a virtual wheelbase L of the trailing unit (110-2); and determining (306), by the processing circuitry (402), a desired vertical load on the coupling (230, 240, 250) based on the coupling load capability.

Example 14: The computer-implemented method (300) of example 13, comprising acquiring the current value of the vertical load F₁ on the coupling (230, 240, 250) by a first controller (160-1) associated with the preceding unit (110-1) and transmitting the current value of the vertical load F₁ on the coupling to a second controller (160-2) associated with the trailing unit (110-2).

Example 15: The computer-implemented method (300) of example 13 or 14, comprising determining the coupling load capability F_{1,cap} by a second controller (160-2) associated with the trailing unit (110-2) and transmitting the coupling load capability F_{1,cap} to a first controller (160-1) associated with the preceding unit (110-1).

Example 16: The computer-implemented method (300) of any of examples 13 to 15, comprising determining the coupling load capability F_{1,cap} by determining a maximum value Lₘₐₓ and/or a minimum value Lₘᵢₙ for the virtual wheelbase L of the trailing unit (110-2), and/or determining a maximum value Mₘₐₓ and/or a minimum value Mₘᵢₙ for the payload of the trailing unit (110-2).

Example 17: The computer-implemented method (300) of any of examples 13 to 16, wherein the coupling load capability F_{1,cap} comprises a maximum coupling load capability F_{1,cap,max} and/or a minimum coupling load capability F_{1,cap,min}.

Example 18: The computer-implemented method (300) of any of examples 13 to 17, comprising determining the desired vertical load F_{1,req} by a first controller (160-1) associated with the preceding unit (110-1) and transmitting the desired vertical load F_{1,req} to a second controller (160-2) associated with the trailing unit (110-2).

Example 19: The computer-implemented method (300) of any of examples 13 to 18, comprising determining the desired vertical load F_{1,req} based on a maximum coupling load limit F_{1,max}.

Example 20: The computer-implemented method (300) of any of examples 13 to 19, comprising determining the desired vertical load F_{1,req} based on a desired increase to a load that can be carried by the trailing unit (110-2) and/or a desired redistribution of traction between the trailing unit (110-2) and the preceding unit (110-1).

Example 21: The computer-implemented method (300) of any of examples 13 to 20, wherein the virtual wheelbase L of the trailing unit (110-2) is defined between the coupling (230, 240, 250) and a load centre G of the axles (270) of the trailing unit (110-2).

Example 22: The computer-implemented method (300) of any of examples 13 to 21, comprising providing the desired vertical load F_{1,req} by adjusting the load on at least one axle (270) of the trailing unit (110-2) such that the longitudinal position of the load centre G of the axles (270) of the trailing unit (110-2) is translated.

Example 23: The computer-implemented method (300) of example 22, comprising adjusting the load on at least one axle (270) of the trailing unit (110-2) by adjusting a suspension parameter associated with the axle (270).

Example 24: A computer program product comprising program code for performing, when executed by processing circuitry (402), the computer-implemented method (300) of any of examples 13 to 23.

Example 25: A non-transitory computer-readable storage medium comprising instructions, which when executed by processing circuitry (402), cause the processing circuitry to perform the computer-implemented method (300) of any of examples 13 to 23.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification. there have been disclosed aspects for purposes of illustration only and not for purposes of limitation, the scope of the disclosure being set forth in the following claims.

What is claimed is:

1. A computer system for controlling a vertical load on a coupling between units of a vehicle combination comprising a trailing unit and a preceding unit, wherein the trailing unit comprises two or more axles and is coupled to the preceding unit via the coupling, the computer system comprising processing circuitry configured to:
acquire a current value of a vertical load F₁ on the coupling;
determine a coupling load capability F_{1,cap} based on the current value of the vertical load F₁ on the coupling and a current value of a virtual wheelbase L of the trailing unit; and
determine a desired vertical load F_{1,req} on the coupling based on the coupling load capability F_{1,cap}.

2. The computer system of claim 1, wherein the current value of the vertical load F₁ on the coupling is acquired by a first controller associated with the preceding unit and transmitted to a second controller associated with the trailing unit.

3. The computer system of claim 1, wherein the coupling load capability F_{1,cap} is determined by a second controller associated with the trailing unit and transmitted to a first controller associated with the preceding unit.

4. The computer system of claim 1, wherein the processing circuitry is configured to determine the coupling load capability F_{1,cap} by determining a maximum value Lₘₐₓ and/or a minimum value Lₘᵢₙ for the virtual wheelbase L of the trailing unit, and/or determining a maximum value Mₘₐₓ and/or a minimum value Mₘᵢₙ for the payload of the trailing unit.

5. The computer system of claim 1, wherein the coupling load capability F_{1,cap} comprises a maximum coupling load capability F_{1,cap,max} and/or a minimum coupling load capability F_{1,cap,min}.

6. The computer system of claim 1, wherein the desired vertical load F_{1,req} is determined by a first controller associated with the preceding unit and transmitted to a second controller associated with the trailing unit.

7. The computer system of claim 1, wherein the processing circuitry is configured to determine the desired vertical load F_{1,req} based on a maximum coupling load limit F_{1,max}.

8. The computer system of claim 1, wherein the processing circuitry is configured to determine the desired vertical load F_{1,req} based on a desired increase to a load that can be carried by the trailing unit and/or a desired redistribution of traction between the trailing unit and the preceding unit.

9. The computer system of claim 1, wherein the virtual wheelbase L of the trailing unit is defined between the coupling and a load centre G of the axles of the trailing unit.

10. The computer system of claim 1, wherein the processing circuitry is further configured to provide the desired vertical load F_{1,req} by adjusting the load on at least one axle of the trailing unit such that the longitudinal position of the load centre G of the axles of the trailing unit is translated.

11. The computer system of claim 10, wherein the processing circuitry is configured to adjust the load on at least one axle of the trailing unit by adjusting a suspension parameter associated with the axle.

12. A vehicle comprising the computer system of claim 1.

13. A computer-implemented method for controlling a vertical load on a coupling between units of a vehicle combination comprising a trailing unit and a preceding unit, wherein the trailing unit comprises two or more axles and is coupled to the preceding unit via the coupling, the method comprising:
acquiring, by processing circuitry of a computer system, a current value of a vertical load F₁ on the coupling;
determining, by the processing circuitry, a coupling load capability based on the current value of the vertical load F₁ on the coupling and a current value of a virtual wheelbase L of the trailing unit; and
determining, by the processing circuitry, a desired vertical load on the coupling based on the coupling load capability.

14. The computer-implemented method of claim 13, comprising acquiring the current value of the vertical load F₁ on the coupling by a first controller associated with the preceding unit and transmitting the current value of the vertical load F₁ on the coupling to a second controller associated with the trailing unit.

15. The computer-implemented method of claim 13, comprising determining the coupling load capability F_{1,cap} by a second controller associated with the trailing unit and transmitting the coupling load capability F_{1,cap} to a first controller associated with the preceding unit.

16. The computer-implemented method of claim 13, comprising determining the coupling load capability F_{1,cap} by determining a maximum value Lₘₐₓ and/or a minimum value Lₘᵢₙ for the virtual wheelbase L of the trailing unit, and/or determining a maximum value Mₘₐₓ and/or a minimum value Mₘᵢₙ for the payload of the trailing unit.

17. The computer-implemented method of claim 13, comprising determining the desired vertical load F_{1,req} by a first controller associated with the preceding unit and transmitting the desired vertical load F_{1,req} to a second controller associated with the trailing unit.

18. The computer-implemented method of claim 13, comprising providing the desired vertical load F_{1,req} by adjusting the load on at least one axle of the trailing unit such that the longitudinal position of the load centre G of the axles of the trailing unit is translated.

19. A computer program product comprising program code for performing, when executed by processing circuitry, the computer-implemented method of claim 13.

20. A non-transitory computer-readable storage medium comprising instructions, which when executed by processing circuitry, cause the processing circuitry to perform the computer-implemented method of claim 13.
